(19) United States
(12) Patent Application Publication
(10) Pub. No.: US 2010/0085168 A1
(43) Pub. Date: Apr. 8, 2010

(54) TACTILE STIMULATION DEVICE AND APPARATUS USING THE SAME

(76) Inventors: Ki-Uk Kyung, Daejeon (KR); Jun-Seok Park, Daejeon (KR); Dong-Won Han, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/525,165

(22) PCT Filed: Jan. 24, 2008
(86) PCT No.: PCT/KR08/00448

§ 371 Date: Jul. 30, 2009

(30) Foreign Application Priority Data
Feb. 2, 2007 (KR) 10-2007-0010920

(51) Int. Cl. H04B 3/36; H02N 2/04; G09B 21/00

(52) U.S. Cl. 340/407.1; 310/323.02; 340/825.19

(57) ABSTRACT

There are provided a tactile stimulation device that is suitable for portable apparatuses by meeting all requirements such as miniaturization, low power consumption, low noises, prompt response time and sufficient physical force, and an apparatus using the same. The tactile stimulation device may be useful to provide a sufficient level of physical stimuli by arranging a plurality of linear ultrasonic actuators to move linearly in a vertical direction to any of skin contact surfaces and stimulating the skin in a vertical direction under the control of the linear movement of the linear ultrasonic actuators.

### TECHNICAL FIELD

The present invention relates to a tactile stimulation device, and more particularly, to a tactile stimulation device capable of being installed inside various portable apparatuses since it may provide characteristics such as miniaturization, low power consumption, low noises and prompt response time.

### BACKGROUND ART

Information that may be transmitted through conventional electronic apparatuses mainly includes visual information and aural information. However, because it is not sufficient to transmit a wide range of information only through the transmission of this visual information and aural information, there have been various attempts to solve the problems regarding the information transmission. As one representative example, there has been proposed a device for transmitting information by stimulating a tactile sense from human.

Information transmission apparatuses using a tactile sense include an electronic Braille display for visually disabled people, a tactile display apparatus for representing textures of objects, a haptic apparatus using vibration information, etc. These apparatuses use a tactile stimulation device for stimulating a tactile sense by forcing contact portions, which are mainly in contact with the human skins, to physically move.

For example, FIG. 1 shows a tactile transducer as disclosed in U.S. Pat. No. 6,445,284, wherein the tactile transducer has skin contacting rods 1 formed of piezo-electric materials that are bent when electricity is applied thereto, and transmitting tactile sensation by giving a sensation of allowing a human skin to graze when the skin contacting rods 1 extended from the actuator 5 are bent as electricity is applied to an actuator 5 through controlled activation means 10. The tactile transducer is to reproduce tactile sensations using a principle that displacement of the contacting tip is relatively increased due to the low displacement value of its own piezoelectric materials when the skin contacting rods 1 produced are bent in a form of beam.

For the tactile transducer as described above, it is, however, impossible to stimulate a tactile sense effectively since one feels only a grazing on the skin when physical stimuli are weakly applied to the skin.

As an alternative, FIG. 2 shows a tactile transmission unit 20 provided in a mouse, etc. as proposed in Korean Registered Patent No. 0626683. Here, the tactile transmission unit 20 includes a vise 21 having a plurality of fitting grooves that are formed in stepped form; actuators 22 fit into each of the fitting grooves of the vise 21, extended outwardly to the front of vise 21 to be fixed and formed of piezoelectric materials; and a plurality of pins 23 coupled upwardly to the actuators 22 to stimulate actual skins.

The tactile transmission unit 20 configured thus is bent upwardly according to the size of the applied current when a power source is applied through power supply unit 24 according to the control signal of a controller 26, and gives physical stimuli to the skin by allowing pins 23 coupled to the actuators 22 to move upwardly/downwardly. Furthermore, the technique is to control the current signal to detect a pressure value by means of a sensor 25, thereby applying a desired level of the physical stimuli to the skin.

However, the tactile transmission unit 20 requires a larger power source to give sufficient stimuli because the stimuli may be usually varied according to the current size, which leads to the increase in the size of a power supply unit. Also, the tactile transmission unit 20 is not suitable for portable apparatuses since a device for stimulating a tactile sense is complicated and increased in size.

As described above, it is difficult to manufacture a small tactile stimulation device and realize a portable texture and Braille reproduction apparatus since the conventional devices do not meet various requirements such as miniaturization, low power consumption, low noises, prompt response time, sufficient physical force, etc.

### DISCLOSURE OF INVENTION

### Technical Problem

An aspect of the present invention provides a tactile stimulation device that is suitable for portable apparatuses by meeting all requirements such as miniaturization, low power consumption, low noises, prompt response time and sufficient physical force, and an apparatus using the same.

### Technical Solution

According to an aspect of the present invention, there is provided a tactile stimulation device including a plurality of linear ultrasonic actuators, each including an ultrasonic transducer whose displacement is caused by an electrical signal of an ultrasonic frequency range, a moving axis coupled integrally to the ultrasonic transducer to move according to the displacement of the ultrasonic transducer and a mover that surrounds the moving axis and is movable up and down according to the electrical signal, and arranged to move in a vertical direction to a contact surface with which the skin is in contact; and a plurality of contact portions formed integrally with the movers of the linear ultrasonic actuator, respectively.

According to another aspect of the present invention, there is provided a tactile stimulation device, comprising an ultrasonic transducer whose displacement is caused by an electrical signal of an ultrasonic frequency range, a moving axis coupled integrally to the ultrasonic transducer and a mover that surrounds the moving axis and is fixed not to move, wherein a plurality of linear ultrasonic actuators in which the moving axis in the mover move linearly according to the electrical signal are arranged to move in a vertical direction to a contact surface with which the skin is in contact.

Also, the tactile stimulation device according to the present invention may enhance the density of arranged pins by varying lengths of the moving axes in the adjacent linear ultrasonic actuators to dispose the ultrasonic transducers alternately. In this case, the difference in the lengths of the moving axes in the adjacent linear ultrasonic actuators may be higher than the maximum displacement of the movers or the moving axes that move according to the electrical signal so that the adjacent linear ultrasonic actuators cannot prevent their movements with each other.

In addition, according to still another aspect of the present invention, there is provided a portable terminal comprising a tactile stimulation device in which a plurality of linear ultrasonic actuators that move linearly according to an electrical signal of an ultrasonic frequency range are arranged to move in a vertical direction to a contact surface with which the skin is in contact, and to stimulate a tactile sense of the contacted skin through the movement of the linear ultrasonic actuator in the vertical direction, and having an ability to reproduce textures and Braille letters by stimulating a user's tactile sense through the tactile stimulation device.

Furthermore, according to still another aspect of the present invention, there is provided a tactile sensation device including an image acquisition unit for taking a picture of an object to be reproduced to obtain image data of the object; an image processing unit for filtering the image data obtained in the image acquisition unit, and processing the filtered image data into signals; a tactile stimulation unit for arranging a plurality of linear ultrasonic actuators to move in a vertical direction to a contact surface with which the skin is in contact, the linear ultrasonic actuators moving linearly according to an electrical signal of an ultrasonic frequency range, and stimulating a tactile sense of the contacted skin through the movement of the linear ultrasonic actuator in the vertical direction; a driver for linearly driving a plurality of linear ultrasonic actuators by applying an electrical signal of an ultrasonic frequency range to a plurality of the linear ultrasonic actuators, respectively; and a controller for controlling the driver to elicit tactile sensations of the corresponding image according to the image data outputted from the image processing unit.

According to still another aspect of the present invention, there is provided a tactile sensation device including a plurality of linear ultrasonic actuators, each of the linear ultrasonic actuators including an ultrasonic transducer whose displacement is caused by an electrical signal of an ultrasonic frequency range, a moving axis coupled to the ultrasonic transducer to move according to the displacement of the ultrasonic transducer and a mover surrounding the moving axis; a cover formed integrally with the respective movers of a plurality of the linear ultrasonic actuators and having a plurality of holes through the moving axes are passed according to the displacement of the ultrasonic transducer; and a base for supporting a plurality of the linear ultrasonic actuators.

In this case, the ultrasonic transducers may be disposed alternately by varying lengths of the moving axes in the adjacent linear ultrasonic actuators, and therefore the ultrasonic transducers may be disposed alternately in different heights from the adjacent ultrasonic transducers.

Also, the base may include a plurality of supports for supporting each of a plurality of the linear ultrasonic actuators by adjusting the heights of a plurality of the linear ultrasonic actuators.

In addition, a plurality of the linear ultrasonic actuators may be disposed in a matrix type.

Furthermore, the tactile sensation device according to the present invention may further include contact portions provided integrally in upper portions of the moving axes to transmit tactile sensations of the skin.

### Advantageous Effects

As described above, the tactile stimulation device according to the present invention may be useful to give characteristics such as miniaturization, low power consumption, sufficient physical stimuli and prompt response time by displaying a plurality of linear ultrasonic actuators to generate physical stimuli in a vertical direction, thereby providing a tactile stimulation function and various functions using the tactile stimulation function to portable apparatuses since the tactile stimulation device may be installed inside the portable apparatuses.

### BRIEF DESCRIPTION OF THE DRAWINGS

FIG. 1 is a configurational view illustrating a conventional tactile stimulation device.

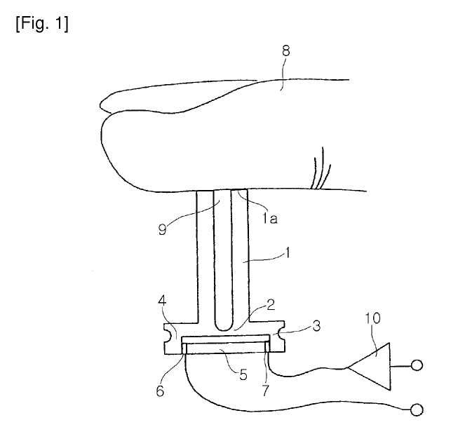

FIG. 2 is a configurational view illustrating another conventional tactile stimulation device.

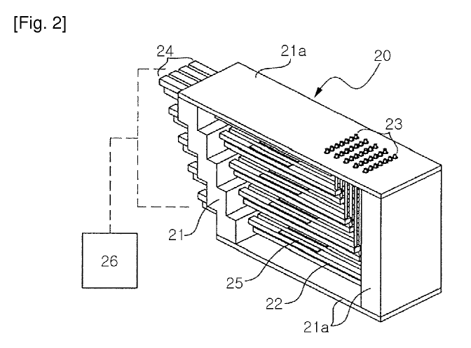

FIG. 3 is a basic structural view illustrating a linear ultrasonic actuator.

FIG. 4 is a configurational view illustrating a tactile stimulation device according to one exemplary embodiment of the present invention.

FIG. 5 is a diagram illustrating an operation principle of the tactile stimulation device as shown in FIG. 4.

FIG. 6 is a configurational view illustrating a tactile stimulation device according to another exemplary embodiment of the present invention.

FIG. 7 is a diagram illustrating an operation principle of the tactile stimulation device as shown in FIG. 6.

FIG. 8 is a diagram illustrating an array configuration of linear ultrasonic actuators in the tactile stimulation device according to the present invention.

FIG. 9 is a diagram illustrating one example of a portable terminal provided with the tactile stimulation device according to the present invention.

FIG. 10 is a perspective view illustrating a texture and Braille reproduction apparatus using the tactile stimulation device according to the present invention.

FIG. 11 is a functional block view illustrating a configuration of the texture and Braille reproduction apparatus as shown in FIG. 10.

### BEST MODE FOR CARRYING OUT THE INVENTION

Hereinafter, exemplary embodiments of the present invention will now be described in detail with reference to the accompanying drawings. However, the description proposed herein is just a preferable example for the purpose of illustrations only, not intended to limit the scope of the invention, so it should be understood that other equivalents and modifications could be made thereto without departing from the spirit and scope of the invention. It is considered that parts having the same configuration and functions have substantially the same reference numerals in the accompanying drawings of the present invention.

In the entire specification, it should be noted that when a portion “is connected to” other portions, the portion can be directly connected to the other portions or indirectly connected to the other portions with intervening any of elements present. In addition, it should be noted that a phrase that a portion “includes” an element(s) means that the portion does not exclude but include the other elements unless otherwise stated herein.

For the present invention, the linear ultrasonic actuator is used to stimulate a tactile sense, and is a linear motor that is widely used to drive a lens of a mobile phone, camera, etc.

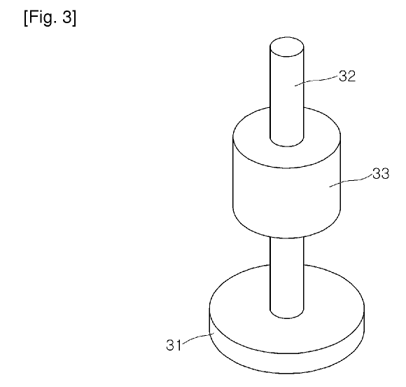

FIG. 3 shows a basic configuration of a linear ultrasonic actuator used in the present invention. Here, the linear ultrasonic actuator includes an ultrasonic transducer 31 composed of piezoelectric materials and an electrode to cause displacement according to an electrical signal of an ultrasonic frequency range; a moving axis 32 coupled to the ultrasonic transducer 31 to engage with the ultrasonic transducer 31 according to the displacement of the ultrasonic transducer 31; and a mover 33 that moves along the moving axis 32.

The ultrasonic transducer 31 is preferably disk-shaped transducers with a bimorph type that causes concave and convex bending displacement, and the moving axis 32 in a rod form is engaged with the ultrasonic transducer 31 according to the displacement of the ultrasonic transducer 31 to move up and down. The mover 33 is formed to surround at least some of a surface of the moving axis 32 so that it can be closely attached to the surface of the moving axis 32 to maintain a constant friction. Therefore, the mover 33 moves or does not move along with the moving axis 32 at a moving speed of the moving axis 32.

The linear ultrasonic actuator configured thus functions to convert displacement of the ultrasonic transducer 31 into linear displacement of the mover 33, and therefore the displacement of the mover 33 may be adjusted by controlling an electrical signal of an ultrasonic frequency range that is applied to the ultrasonic transducer 31. In this case, a level of the linear movement may be adjusted by controlling the frequency, rather than the size, of an electrical signal applied to the ultrasonic transducer since the vertical movement of the mover 33 is controlled according to the vibration speed. As a result, a power supply unit for driving the linear ultrasonic actuator is decreased in size.

The tactile stimulation device according to the present invention may give a sufficient level of physical stimuli by arranging a plurality of the above mentioned linear ultrasonic actuators to move linearly in a vertical direction to any of skin contact surfaces and stimulating the skin in a vertical direction under the control of the linear movement of the linear ultrasonic actuators, and also realize low power consumption, low noises, prompt response time and miniaturization.

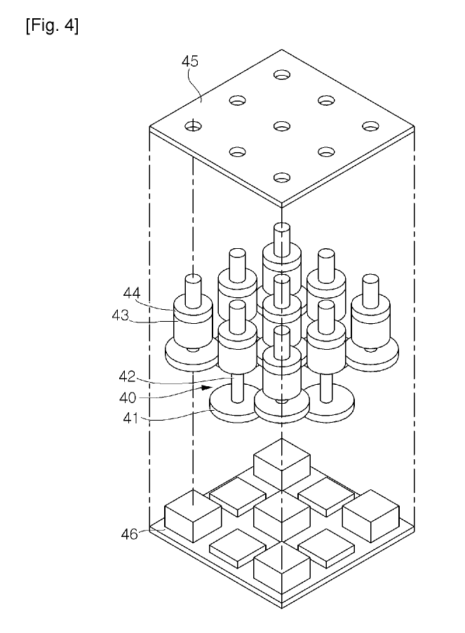

FIG. 4 is a perspective view illustrating a configuration of a tactile stimulation device according to one exemplary embodiment of the present invention.

Referring to FIG. 4, the tactile stimulation device of the present invention includes ultrasonic actuators 40, each including an ultrasonic transducer 41 whose displacement is caused by an electrical signal of an ultrasonic frequency range, a moving axis 42 coupled integrally to the ultrasonic transducer 41 to move according to the displacement of the ultrasonic transducer 41 and a mover that surrounds the moving axis and is movable up and down according to the electrical signal, and arranged to move in a vertical direction to a contact surface with which the skin is in contact; and a plurality of contact portions formed integrally with the movers of the linear ultrasonic actuators 40, respectively.

The contact portion 44 preferably has a tip formed in a pin shape, and also has a groove formed therein to move linearly along the moving axis 42 together with the mover 43.

In addition, the above-mentioned tactile stimulation device may further include a cover 45 having a plurality of holes formed therein, wherein a plurality of the contact portions are extruded through the holes thereof. The cover 45 protects hardware and circuits inside the tactile stimulation device.

In order to enhance density of contact portions 44 and miniaturize the contact portions 44 in the present invention, the adjacent linear ultrasonic actuators 40 are also displayed alternately by varying the lengths of the moving axes 42 of the adjacent linear ultrasonic actuators 40. In this case, the density of the contact portions 44 with which the skin is in contact may be increased by disposing a plurality of the linear ultrasonic actuators 40 in the maximum compact manner, and therefore it is possible to reproduce a finer tactile sensation, or significantly reduce the size of the tactile stimulation device itself.

Furthermore, the tactile stimulation device of the present invention includes a plurality of supports that are formed to adjust heights of the respective ultrasonic transducers 41 of the linear ultrasonic actuators 40 in which the moving axes 42 have different lengths, so that a plurality of the linear ultrasonic actuators 40 in which the moving axes 42 have different lengths can have the same displacement range on the basis of the skin contact surface, and further include a base 46 for supporting a plurality of the linear ultrasonic actuators.

As shown in FIG. 4, the base 46 stably may support the linear ultrasonic actuators 40 by forming supports that are extruded upwardly in heights corresponding to the heights of the respective ultrasonic transducers 41 when the linear ultrasonic actuators 40 are disposed to have the same reference height of the contact portion 44.

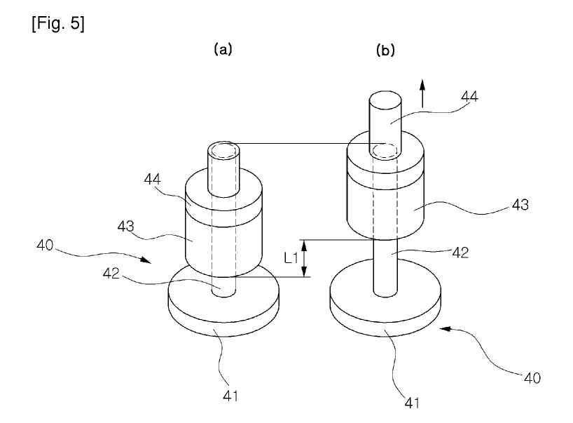

FIG. 5 is a diagram illustrating an operation principle of generating physical stimuli in the tactile stimulation device as shown in FIG. 4. When an electrical signal of a predetermined ultrasonic frequency range is applied to the ultrasonic transducers 41 in an initial state as shown in FIG. 5 (a), bending displacement of the respective ultrasonic transducers 41, and thus displacement of the moving axes 42 are generated, and therefore the ultrasonic transducers 41 move in a vertical direction to the movers 43, and the contact portions 44 coupled to the movers 43 also move upwardly in a vertical direction as high as displacement L1 of the movers 43, which generates physical stimuli in the vertical direction to the contacted skin. Therefore, textures and Braille letters may be reproduced by controlling an electrical signal, applied to a plurality of the linear ultrasonic actuators 40, to vary the displacement of a plurality of the disposed contact portions 44.

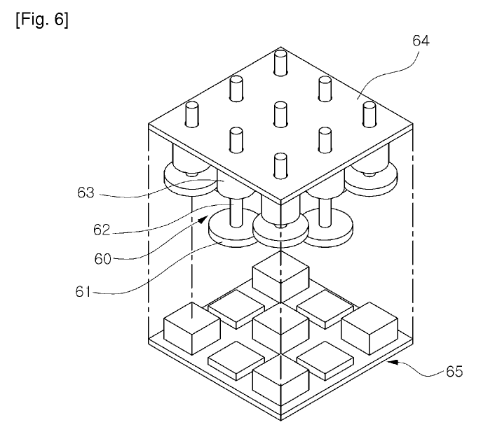

FIG. 6 is a perspective view illustrating a tactile stimulation device according to another exemplary embodiment of the present invention.

The tactile stimulation device as shown in FIG. 6 includes an ultrasonic transducer 61 whose displacement is caused by an electrical signal of an ultrasonic frequency range, a moving axis 62 coupled integrally to the ultrasonic transducer 61 and a mover 63 that surrounds the moving axis 62 and is fixed not to move, wherein a plurality of linear ultrasonic actuators 60 in which the moving axis 62 in the mover 63 move linearly according to the electrical signal are arranged to move in a vertical direction to a contact surface with which the skin is in contact.

The tactile stimulation device as shown in FIG. 6 uses pins for applying physical stimuli to the moving axes 62 of the linear ultrasonic actuators 60. In this case, the moving axes 62 may be used as they are, or contact portions (not shown) may be further formed integrally in tips of the moving axes 62 to be in contact with the skin.

In addition, the tactile stimulation device may use a cover 64 to fix the movers 62. That is, the movers 62 are coupled integrally to the cover 64, and therefore the moving axes 62 move inwardly through holes of the fixed cover 64 and the mover 62 in a vertical direction.

Like the exemplary embodiment as shown previously in FIG. 4, the adjacent ultrasonic transducers 62 are disposed alternately by varying lengths of the moving axes 62 of the adjacent linear ultrasonic actuators 60 so as to miniaturize the tactile stimulation device and enhance its arrangement density. In this case, it is possible to reproduce a finer tactile sensation, or significantly reduce the size of the tactile stimulation device itself by disposing a plurality of the linear ultrasonic actuators 60 in the maximum compact manner.

Furthermore, the tactile stimulation device of the present invention includes a plurality of supports that are formed to adjust heights of the respective ultrasonic transducers 61 of the linear ultrasonic actuators 60 in which the moving axes 62 have different lengths, so that a plurality of the linear ultrasonic actuators 60 in which the moving axes 62 have different lengths can have the same displacement range on the basis of the skin contact surface, and further include a base 65 for supporting a plurality of the linear ultrasonic actuators.

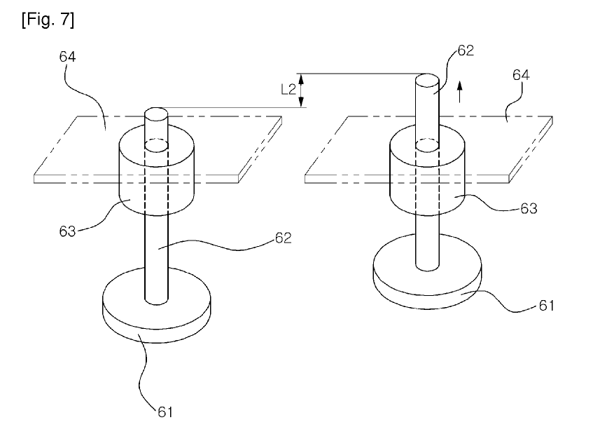

FIG. 7 is a diagram illustrating an operation principle of generating physical stimuli in the tactile stimulation device as shown in FIG. 6. When an electrical signal of a predetermined ultrasonic frequency range is applied to the ultrasonic transducers 61 in an initial state as shown in FIG. 7 (a), bending displacement of the respective ultrasonic transducers 61, and thus displacement of the moving axes 62 are generated, and therefore the moving axes 62 move inversely in a vertical direction as high as displacement L2 of the moving axis 62 since the mover 63 is fixed not to move along, thereby stimulating the contacted skin. In this case, the movement distance L2 of the moving axes 62 may be adjusted by controlling an electrical signal applied to the linear ultrasonic actuator 60.

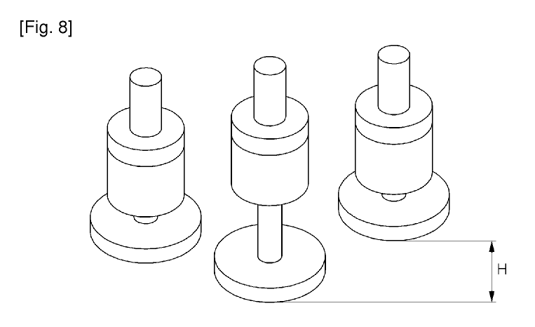

As described above in the two exemplary embodiments, the tactile stimulation device according to the present invention, for the tactile stimulation device, the ultrasonic transducers may be disposed alternately by varying lengths of the moving axes between the adjacent linear ultrasonic actuators, as shown in FIG. 8, so as to dispose the linear ultrasonic actuators, arranged to stimulate a tactile sense, in a more compact manner. For example, when the linear ultrasonic actuators are disposed in a matrix form, moving axes of the ultrasonic transducers in an even matrix preferably have a longer (or, shorter) length, whereas moving axes of the ultrasonic transducers in an odd matrix preferably have a shorter (or, longer) length.

In this case, the difference H in the lengths of the moving axes between the adjacent linear ultrasonic actuators is preferably higher than the maximum displacement of the movers or the moving axes that move according to the electrical signal of an ultrasonic frequency range. Therefore, it is possible for the adjacent linear ultrasonic actuators to move along without any hindrance.

As described above, the tactile stimulation device according to the present invention may be useful to realize characteristics such as miniaturization, low power consumption and prompt response time by employing a linear ultrasonic actuator that is manufactured in small size, does not generate even very small noises and has low power consumption. Therefore, the tactile stimulation device may be used in a tactile reproduction apparatus for reproducing textures and Braille letters by directly physically stimulating the skin using a plurality of linear ultrasonic actuators, and particularly applied to portable terminals to give a function to stimulate a tactile sense.

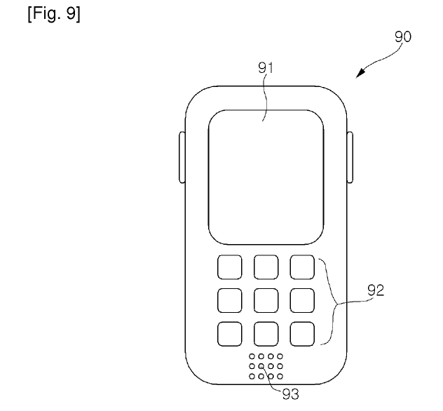

That is to say, the tactile stimulation device 93 of the present invention as configured thus may be installed inside a portable terminal 90 including mobile phones, PDA, etc. to give an ability to reproduce textures and Braille letters to the portable terminal 90, or may be used as alarm units except for ringing tones or vibrations, as shown in FIG. 9.

As described above, it is shown that the tactile stimulation device 93 is installed around a key pad 92 of the portable terminal 90, but the tactile stimulation device 93 may be formed around a user screen 91 or a portion (e.g., a side surface) that is in contact with a hand when one holds the portable terminal 90.

As described above, the portable terminal 90 may provide a variety of applications using an ability to stimulate a tactile sense without the increase in its size or the burdens to a power supply unit by installing tactile stimulation device 93 according to the present invention thereinside.

As another alternative, portable tactile sensation devices may be realized using the tactile stimulation device according to the present invention.

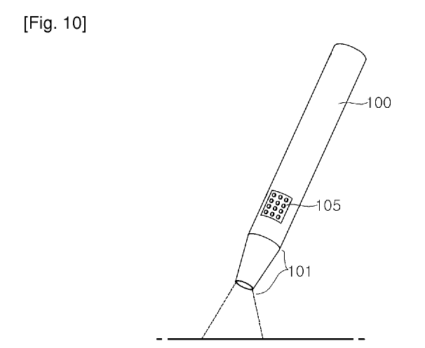

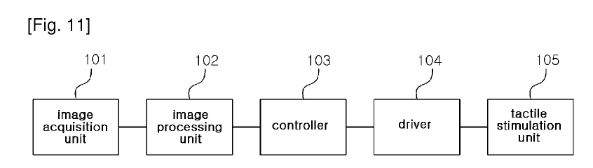

FIG. 10 is a perspective view illustrating one example of a texture and Braille reproduction apparatus that is applied to the present invention, and FIG. 11 is a functional block view illustrating the texture and Braille reproduction apparatus.

Referring to FIGS. 10 and 11, the tactile sensation device 100 is realized in shapes (e.g., a pen shape) that are comfortable to hold and use the texture and Braille reproduction apparatus, and a tactile stimulation unit 105 as shown in FIG. 4 or 6 is installed inside a region that is in contact with fingers. In addition, the tactile sensation device 100 has an ability to control the tactile stimulation device 105 by obtaining images of subjects (e.g., objects, Braille letters, photographs, or the like) whose tactile sensation is reproduced and reproducing the obtained tactile sensations of the subjects.

For this purpose, the tactile sensation device 100 includes an image acquisition unit 101 for taking a photograph of a subject to be reproduced and obtaining image data of the subject; an image processing unit 102 for filtering the image data obtained in the image acquisition unit 101 and processing the filtered image data into signals, a driver 104 for linearly driving a plurality of linear ultrasonic actuators provided in the tactile stimulation unit 105 by applying an electrical signal of an ultrasonic frequency range to a plurality of the linear ultrasonic actuators, respectively; and a controller 103 for controlling the driver 104 to produce textures and Braille letters of the corresponding image according to the image data outputted from the image processing unit 102, as shown in FIG. 11.

The tactile sensation device 100 may be easily manufactured in small size since sufficient physical stimuli are generated through the tactile stimulation unit 105 that is realized with a plurality of the linear ultrasonic actuators proposed in the present invention, and may reduce burdens to power supply that is used to drive the tactile sensation device 100 by lowering power consumption.

Also, textures and Braille letters of a subject whose tactile sensation is processed through the image acquisition unit 101 and the image processing unit 102 may be more effectively reproduced by generating physical stimuli in the tactile stimulation unit 105 in a vertical direction to reproduce a tactile sensation.

The image acquisition unit 101 may be realized with conventional image-taking unit (e.g., lens) and CCD elements, and an image processing and controlling methods for reproducing tactile sensations such as Braille letters and textures may also be realized by applying generally known processing systems such as Braille reproduction apparatuses or pattern reproduction apparatuses.

While the present invention has been shown and described in connection with the exemplary embodiments and the accompanying drawings, it will be apparent to those skilled in the art that modifications and variations can be made without departing from the spirit and scope of the invention as defined by the appended claims.

### INDUSTRIAL APPLICABILITY

As described above, the tactile stimulation device according to the present invention may be useful to give characteristics such as miniaturization, low power consumption, sufficient physical stimuli and prompt response time by displaying a plurality of linear ultrasonic actuators to generate physical stimuli in a vertical direction, thereby providing a tactile stimulation function and various functions using the tactile stimulation function to portable apparatuses since the tactile stimulation device may be installed inside the portable apparatuses.

1. A tactile stimulation device, comprising:
a plurality of linear ultrasonic actuators arranged to move in a vertical direction to a contact surface with which the skin is in contact; and
a plurality of contact portions formed integrally with the movers of the linear ultrasonic actuators, respectively,
wherein each of the linear ultrasonic actuators comprises:
an ultrasonic transducer whose displacement is caused by an electrical signal of an ultrasonic frequency range;
a moving axis coupled integrally to the ultrasonic transducer to move according to the displacement of the ultrasonic transducer; and
a mover that surrounds the moving axis and is movable up and down according to the electrical signal.

2. The tactile stimulation device of claim 1, further comprising a cover having a plurality of holes formed therein, wherein a plurality of the contact portions are extruded through the holes thereof.

3. The tactile stimulation device of claim 1, wherein the ultrasonic transducers of the linear ultrasonic actuators are disk-shaped transducers with a bimorph type that are concavely and convexly changed in shape according to the electrical signal.

4. The tactile stimulation device of claim 1, wherein the ultrasonic transducers are disposed alternately by varying lengths of the moving axes in the adjacent linear ultrasonic actuators.

5. The tactile sensation device of claim 4, wherein the ultrasonic transducers are disposed alternately in different heights from the adjacent ultrasonic transducers.

6. The tactile stimulation device of claim 4, wherein difference in the lengths of the moving axes between the adjacent linear ultrasonic actuators is longer than the maximum displacement of the movers or the moving axes that move according to the electrical signal.

7. The tactile stimulation device of claim 4, further comprising a base including a plurality of supports to support a plurality of the linear ultrasonic actuators, the supports being formed to adjust heights of the respective ultrasonic transducers of the linear ultrasonic actuators in which the moving axes have different lengths.

8. A tactile stimulation device, comprising:
a plurality of linear ultrasonic actuators arranged to move in a vertical direction to a contact surface with which the skin is in contact; and
contact portions formed integrally in tips of the moving axes to be in contact with the skin,
wherein each of the linear ultrasonic actuators comprises:
an ultrasonic transducer whose displacement is caused by an electrical signal of an ultrasonic frequency range;
a moving axis coupled integrally to the ultrasonic transducer to engage with the ultrasonic transducer according to the displacement of the ultrasonic transducer; and
a mover formed to move along the moving axis, wherein the mover is fixed not to move and the moving axis moves linearly in the mover according to the electrical signal of an ultrasonic frequency range to stimulate a tactile sense.

9. The tactile stimulation device of claim 8, further comprising a cover having a plurality of holes that are formed therein so that the moving axes can be extruded through the holes and to which each of the movers is coupled fixedly thereto.

10. The tactile stimulation device of claim 8, wherein the ultrasonic transducers of the linear ultrasonic actuators are disk-shaped transducers with a bimorph type that are concavely and convexly changed in shape according to the electrical signal.

11. The tactile stimulation device of claim 8, wherein the ultrasonic transducers are disposed alternately by varying lengths of the moving axes in the adjacent linear ultrasonic actuators.

12. The tactile sensation device of claim 11, wherein the ultrasonic transducers are disposed alternately in different heights from the adjacent ultrasonic transducers.

13. The tactile stimulation device of claim 11, wherein difference in the lengths of the moving axes between the adjacent linear ultrasonic actuators is longer than the maximum displacement of the movers or the moving axes that move according to the electrical signal.

14. The tactile stimulation device of claim 11, further comprising a base including a plurality of supports to support a plurality of the linear ultrasonic actuators, the supports being formed to adjust heights of the respective ultrasonic transducers of the linear ultrasonic actuators in which the moving axes have different lengths.

15. A portable terminal comprising a tactile stimulation device in which a plurality of linear ultrasonic actuators that move linearly according to an electrical signal of an ultrasonic frequency range are arranged to move in a vertical direction to a contact surface with which the skin is in contact, and to stimulate a tactile sense of the contacted skin through the movement of the linear ultrasonic actuator, and having an ability to reproduce textures and Braille letters by stimulating a user's tactile sense through the tactile stimulation device.

16. The portable terminal of claim 15, wherein each of the linear ultrasonic actuators comprising an ultrasonic transducer whose displacement is caused by an electrical signal of an ultrasonic frequency range, a moving axis coupled integrally to the ultrasonic transducer to engage with the ultrasonic transducer according to the displacement of the ultrasonic transducer, a mover formed to move along the moving axis, and a contact portion formed to engage with the mover and stimulate a tactile sense through the linear movement of the ultrasonic transducer, wherein the mover and the contact portion move linearly according to the electrical signal of an ultrasonic frequency range to stimulate a tactile sense.

17. The portable terminal of claim 15, wherein each of the linear ultrasonic actuator comprising an ultrasonic transducer whose displacement is caused by an electrical signal of an ultrasonic frequency range, a moving axis coupled integrally to the ultrasonic transducer to engage with the ultrasonic transducer according to the displacement of the ultrasonic transducer, and a mover formed to move along the moving axis, wherein the mover is fixed not to move and the moving axis moves linearly in the mover according to the electrical signal of an ultrasonic frequency range to stimulate a tactile sense.

18. A tactile sensation device, comprising:
an image acquisition unit for taking a picture of an object to be reproduced to obtain image data of the object;
an image processing unit for filtering the image data obtained in the image acquisition unit, and processing the filtered image data into signals;
a tactile stimulation unit for arranging a plurality of linear ultrasonic actuators to move in a vertical direction to a contact surface with which the skin is in contact, the linear ultrasonic actuators moving linearly according to an electrical signal of an ultrasonic frequency range, and stimulating a tactile sense of the contacted skin though the movement of the linear ultrasonic actuator in the vertical direction;
a driver for linearly driving a plurality of linear ultrasonic actuators by applying an electrical signal of an ultrasonic frequency range to a plurality of the linear ultrasonic actuators, respectively; and
a controller for controlling the driver to elicit tactile sensations of the corresponding image according to the image data outputted from the image processing unit.

19. The tactile sensation device of claim 18, wherein the linear ultrasonic actuator comprises a plurality of linear ultrasonic actuators, each including an ultrasonic transducer whose displacement is caused by an electrical signal of an ultrasonic frequency range, a moving axis coupled integrally to the ultrasonic transducer to engage with the ultrasonic transducer according to the displacement of the ultrasonic transducer, mover formed to move along the moving axis, and a contact portion formed to engage with the mover and stimulate a tactile sense through the linear movement of the ultrasonic transducer, wherein the mover and the contact portion move linearly according to the electrical signal of an ultrasonic frequency range to stimulate a tactile sense.

20. The tactile sensation device of claim 18, wherein each of the linear ultrasonic actuators comprising an ultrasonic transducer whose displacement is caused by an electrical signal of an ultrasonic frequency range, a moving axis coupled integrally to the ultrasonic transducer to engage with the ultrasonic transducer according to the displacement of the ultrasonic transducer, and a mover formed to move along the moving axis.

21-29. (canceled)
